(19) United States
(12) Patent Application Publication
(10) Pub. No.: US 2011/0170702 A1
(43) Pub. Date: Jul. 14, 2011

(54) AUDIO HEADSET AND AUDIO PLAYER

(75) Inventor: Paul Leonard Bays, Muntelier (CH)

(73) Assignee: BAYS.I.C.S GmbH, Muntelier (CH)

(21) Appl. No.: 12/672,728

(22) PCT Filed: Aug. 6, 2008
(86) PCT No.: PCT/GB2008/050671

§ 371 Date: Mar. 25, 2011

(30) Foreign Application Priority Data
Aug. 6, 2007 (GB) 0715273.9

(51) Int. Cl. H04R 1/10

(52) U.S. Cl. 381/74

(57) ABSTRACT

The present invention provides an audio headset (1) comprising a resilient headband (2) adapted to extend partially around and grip a wearer s head, the resilient headband (2) having first and second end portions (4),and first and second earphones (6) attached by pliable members (8) to the first and second end portions (4), respectively, wherein the resilient headband is arranged to conduct an audio signal from an audio signal generator to the earphones. The resilient headband can be worn around the back of the head. The audio headset is particularly suitable for use during sports and may be provided in a waterproof version for use whilst swimming. The audio headset may be used with a removable audio player (110) having an integral USB plug (118). The removable audio player (110) may be adapted to receive digital audio signals and power to recharge an internal battery through the USB plug in a first operating mode, and to output analogue audio signals 17 through the USB plug, to the audio headset, in a second operating mode.

### FIELD OF THE INVENTION

The present invention relates to an audio headset, an audio player, and kits including an audio headset and an audio player.

### BACKGROUND TO THE INVENTION

A variety of portable audio equipment has been developed over time for use during exercise. It is well known to provide a portable audio device, such as a portable audio player including solid state memory for storing audio tracks in formats such as MP3, AAC and WMA, which is carried by a user and connected to a headset comprising head/earphones via a trailing connecting wire. However, such wired devices are not ideal for use during exercise as the trailing wire is easily tangled and may present a danger to the user.

Accordingly, it would be desirable to provide a wireless headset device for facilitating the safe and convenient operation of a portable audio device during exercise.

One such device is disclosed in EP 1,701,582 A1 (Chan), wherein there is provided a headset comprising headphones which are worn over the ears and an audio player in which the electronic components for generating sound are situated within the headphones, over a wearer's ears. This ensures that no trailing wires are present between the audio player and the headset. However, such headphone devices are bulky and again not ideally suited for a wearer who is exercising.

U.S. 2006/0088171 A1 (Yeh) discloses a wireless earphone type headset comprising an audio player which is demountably retained in, or integrated, with a headband and earphones which are worn within the ear-holes, wherein the headset is secured to a wearer's head by using the earphones to grip the ears. The headset disclosed in Yeh is less bulky over the ears than the headset disclosed in Chan.

However, such a device is still bulky and consequently is not ideal for use during exercise. Furthermore, the device has poor aerodynamic and hydrodynamic features as it is worn above the head. Such devices also provide a degree of discomfort to the wearer as the earphones press into the wearer's ears to provide the necessary grip. Furthermore, such devices are not fully adjustable to fit any wearer's head, and as such can cause further discomfort.

The present invention aims to provide an improved headset without trailing wires which reduces bulk, improves comfort, is adjustable to fit users with a range of head sizes, has good aerodynamic and/or hydrodynamic properties and is adapted for use in wet conditions such as during running, cycling or water sports such as swimming.

### SUMMARY OF THE INVENTION

According to the first aspect of the present invention, there is provided an audio headset comprising a headband having first and second end portions, and first and second earphones, characterised in that the headband is resilient and adapted to extend partially around and grip a wearer's head, the first and second earphones are attached by pliable members to the first and second end portions, respectively, and the resilient headband is arranged to conduct an audio signal from an audio signal generator to the earphones.

Preferably, the resilient headband is adapted to be worn around the back of a wearer's head. Preferably, the resilient headband has a generally U shaped portion intermediate the first and second end portions. The resilient headband is typically configured to fit closely to a wearer's head. Typically, the contours of the resilient headband conform to the contours of the back of a wearer's head, for example the headband may have a curved profile arranged to curve downwards to match the curve of a wearer's neckline when worn behind the head.

Preferably, the resilient headband comprises cushioning on a head engaging side thereof, intermediate the first and second end portions.

The resilient headband may comprise two hinges, each of which is intermediate of an end portion and the middle of the resilient headband. The hinges may allow each end portion to fold inwards within the plane of the resilient headband. Alternatively, or additionally, the hinged attachments may allow movement vertically out of the plane, allowing vertical adjustment of the generally U shaped portion.

Each pliable member may be plastically deformable but capable of retaining its shape when plastically deformed. Typically, the pliable members are more flexible than the resilient headband. Accordingly, the pliable members preferably do not contribute significantly to the overall grip of the resilient headband. Each pliable member may be entirely flexible. For example, each pliable member may be a flexible wire.

Preferably, each pliable member is sufficiently short such that it cannot engage with a wearer's clothes, arms or other extremities. Preferably, also, each pliable member is sufficiently long such that it is extendable from the respective end portion of the resilient headband to allow the attached earphone to engage any size of a wearer's ears and head. Typically, each pliable member is less than 10 cm in length, preferably less than 5 cm.

Preferably, the headset is operable to communicate an audio signal from an audio signal generator to the earphones. Preferably, the audio signal generator is an audio player capable of storing and playing (and preferably also decoding) digital audio files. Typically, the audio player is capable of storing, decoding and playing one or more of MP3 (MPEG-1 audio layer 3), AAC (Advanced Audio Coding), WMA (Windows Media Audio) format digital audio files. The audio player may also be operable to receive and play streaming audio files, such as internet radio stations. Preferably, the audio player comprises a plurality of user operable function keys for controlling play back of stored digital audio files. Typically, the audio player includes a solid state memory for retrievably storing digital audio files.

The audio signal generator may comprise an audio player which is integral to the resilient headband. In this case, the audio headset preferably comprises an internal rechargeable power source, typically within the resilient headband. Preferably, the resilient headband further comprises a plurality of electrical contacts. The plurality of electrical contacts may be connectable to a cable by a clipping formation attached to the cable. Preferably, the internal rechargeable power source is connected to the electrical contacts. Preferably, the electrical contacts are connectable to a recharging power source by the cable to enable the internal power supply to recharge. Preferably, the recharging power source is the USB (Universal Serial Bus) port of a personal computer. Alternatively, or additionally, the audio headset may comprise electrical contacts (typically within the resilient headband) for detachably connecting the audio headset to an external power source, such as a portable mains electricity powered charger, for recharging the internal power supply.

Preferably, the resilient headband comprises a plurality of function keys for controlling the play back of stored digital audio files. Preferably, also, the resilient headband comprises a function key for controlling the power supply to the resilient headband, such as an on/off key.

Preferably, the cable is also connectable to an external interface, such as a personal computer. The cable may be connectable to a personal computer by a USB connection to enable data transfer from the external interface to the integrated audio signal generator.

Alternatively, the resilient headband is adapted for detachable attachment to an external audio player, which functions as the audio signal generator. In this case, the audio headset need not include an internal power supply. Preferably, the resilient headband comprises an audio player interlace for receiving an audio signal from an audio player, for example, from an audio signal output interface. Preferably, the resilient headband comprises an audio player mounting for demountably retaining an audio player whilst the resilient headband is in electronic communication with the audio player interface.

The resilient headband may comprise an audio player receiving mounting which is operable between a retaining position in which the audio player receiving mounting retains the audio player, and an open position which enables an audio player to be inserted into or removed from the audio player receiving mounting. Typically, the audio player interface communicates electronically with the audio player audio signal output interface to receive an audio signal from an audio player when the audio player receiving mounting is in the retaining position. Preferably, the audio player receiving mounting forms a waterproof seal with a received audio player in the retaining position, which seals the audio player receiving mounting and audio signal output interface from the surrounding volume to protect the audio player receiving mounting and audio signal output interface from water.

Preferably, the audio player receiving mounting is operable between the retaining position and the open position by flexion of the resilient headband. Thus, an audio player can be readily inserted into or removed from the audio player receiving mounting by manual flexion of the resilient headband. Preferably, the audio player receiving mounting adopts the retaining position when no external flexural forces are applied to the resilient headband. Preferably, the audio player receiving mounting adopts the retaining position when the audio headset is worn. For example, the audio player receiving mounting may comprise a recess at the location on the resilient headband which will be behind a wearer's head in use, on the outside surface of the resilient headband. A sealing member can be provided on either side of the recess and the resilient headband can be pre-loaded so that it grips an audio player which is inserted into the recess, between the sealing members, when no external forces are applied to the resilient headband, and also when the audio headset is worn. The audio player interface may extend into the recess.

In a stereo audio headset, the audio signal may comprise a left channel and a right channel and the left channel may be conducted only to the left earphone and the right channel may be conducted only to the right earphone.

The audio player interface may be an audio jack plug. An audio jack plug may function as both an audio signal interface for receiving audio signals and an audio player mounting. The external audio player may comprise an audio jack socket which engages with the audio jack plug when the audio player is retained by the audio player mounting. The audio jack plug is typically a 3.5 mm (male) audio jack plug which is connectable to the 3.5 mm (female) audio jack socket of an audio player. Alternatively, the audio jack plug may be a 2.5 mm (male) audio jack plug which is connectable to the 2.5 mm (female) audio jack socket of an audio player.

Preferably, the audio player interface is a USB plug or, more preferably, a USB socket. The external audio player may comprise a cooperating USB socket or, more preferably, a plug, which is preferably integral to, and more preferably, integral to and fixedly mounted to, the external audio player. The USB plug or socket may function as both an audio player interface and an audio player mounting, or as a component of an audio player mounting.

The external audio player may be operable to output an audio signal through the audio player interface. Thus, the external audio player may be operable to output an audio signal from a USB plug (or socket) which is integral to (and typically also fixedly mounted to) the audio player, to a cooperating USB socket (or plug respectively) which is integral to the resilient headband. Preferably, the external audio player outputs analogue audio signals through the USB plug (or socket) which are received in analogue form by the resilient headband and conducted to the earphones. Typically, the external audio player comprises a battery. Typically, the audio headset does not include a battery. Thus, preferably the only source of electrical power to the headphones is the audio signals transmitted from the external audio player in analogue form through the USB plug (or socket) integral to the external audio player and the USB socket (or plug) integral to the resilient headband.

Thus, the external audio player is preferably operable, in a first mode, to receive audio data digitally through the USB plug (or socket) from, for example, a computer, and operable, in a second mode, to output audio data in analogue form through the USB plug (or socket). Typically, the external audio player is operable to receive power to charge its internal battery in the first mode.

Preferably, the audio headset is waterproof. This is particularly beneficial for use during water sports, such as swimming. Typically, the audio headset and a retained audio player together form a waterproof unit. Typically, the audio headset and the audio player are each waterproof.

Preferably, the audio headset is buoyant, such that it would float on water. In this case, the audio headset may be brightly coloured, such that it is highly visible if floating in water. Preferably, the audio headset, excluding any attached removable audio player, has a density of less than 1.00 gcm⁻³, and preferably less than 0.97 gcm⁻³, and is waterproof so that it floats in water. Preferably, the removable audio player has a density of less than 1.00 gcm⁻³ and is waterproof so that the removable audio player floats. Preferably, the audio headset, and removable audio player, together have a density of less than 1.00 gcm⁻³, and preferably less than 0.97 gcm⁻³, and form a waterproof unit which can float in water. Preferably, the audio headset and attached removable audio player together have a mass of less than 33 g.

Where the audio headset comprises a USB socket for receiving audio signals from a removable player (typically in analogue form), the USB socket may have only three pins for making electrical contact with electrical contacts within a cooperating USB plug. Typically the USB socket is therefore not operable to electrically connect to one of the pins of a USB plug which is integral to a received audio player. As the metal pins of a USB socket are typically dense (e.g. 8 gcm⁻³), this saves weight and facilitates provision of a compact buoyant audio headset. However, by providing three pins, left and right channels and a ground channel can be provided to the earphones. Conceivably, the USB socket may comprise only two pins in a monaural device. Thus, within this specification and the appended claims, the term “USB socket” includes USB sockets omitting one or more pins.

The invention extends in a second aspect to a kit comprising an audio headset according to the first aspect of the present invention having an audio player interface for receiving an audio signal from a removable audio player and an audio player which is adapted to be received by the audio headset and which comprises an audio signal output interface suitable for cooperating with the audio player interface of the audio headset and transmitting audio signals to the audio player interface whilst the audio headset retains the audio player.

The audio player may comprise an integral fixed USB socket, or preferably, a USB plug, which functions as the audio signal output interface. Further optional features of the audio headset and the audio player correspond to those discussed above in relation to the first aspect of the invention, and below in relation to the third through tenth aspects of the invention.

According to a third aspect of the present invention, there is provided an audio headset comprising a headband and at least one earphone, wherein the resilient headband is arranged to conduct an audio signal to the at least one earphone from a USB socket comprising a plurality of pins operable to make contact with some, but not all, corresponding electrical contacts within a cooperating USB plug.

Thus, the invention extends to an audio headset comprising a headband and at least one earphone, wherein the resilient headband is arranged to conduct an audio signal to the at least one earphone from a USB socket having at most three pins for making electrical contact with corresponding electrical contacts within a USB plug.

Preferably, the audio headset is adapted to receive an analogue audio signal from the USB socket. The audio headset is preferably adapted to receive a removable audio player having an integral USB plug. The at least one earphone may comprise first and second earphones and the resilient headband may be arranged to conduct an audio signal to the first and second earphones.

Preferably, the audio headset is waterproof and buoyant. Preferably, the audio headset has a density of less than 1.00 gcm'⁻³, more preferably, less than 0.97 gcm⁻³. Thus, by utilizing a USB socket have at most three pins for making electrical contact with electrical contacts within a USB plug, the audio headset has a lower density than would be the case if the USB socket included a further metal pin. Preferably, the audio headset does not have an integral battery and receives power in use only from a removable audio player having an integral battery.

Further optional features of the audio headset, and removable audio player correspond to those discussed in relation to the first aspect of the invention above. The audio headset may be an audio headset according to the first aspect of the present invention.

According to a fourth aspect of the present invention there is provided an audio player comprising a USB plug or socket, wherein the audio player is operable in a first operating mode to receiving audio data in the form of digital signals through the USB plug or socket and, in a second operating mode, is operable to output audio data in the form of analogue signals through the USB plug or socket.

The audio player preferably includes an internal battery. Typically, the audio player is operable to charge the internal battery through the USB plug or socket, for example, whilst in the first operating mode. Preferably, the USB plug or socket is the only wired electrical interface of the audio player. Thus, a conventional audio jack socket can be omitted, saving weight and facilitating the provision of a waterproof device, or a device which requires only a single connector to be protected from water when attached to an audio headset.

Preferably, the USB plug or socket is a USB plug. Preferably, the audio player is operable to output analogue signals through only some of the pins of the USB plug.

Further optional features of the audio player correspond to those discussed above in relation to the first aspect of the invention.

The invention also extends in a fifth aspect to a kit comprising an audio headset according to the first or second aspect of the invention, having an audio player interface which is a USB socket or plug, and an audio player according to the fourth aspect of the present invention which is operable to be retained by the audio headset.

According to a sixth aspect of the present invention there is provided an audio headset comprising a headband and at least one earphone, wherein the audio headset is adapted to conduct a received audio signal from an audio signal generator to the at least one earphone, characterised in that the audio headset is waterproof and buoyant, having a density of less than 1.00 gcm⁻³.

Preferably, the audio headset further comprises an audio player interface for receiving an audio signal from an audio player capable of storing and playing (and typically also decoding) digital audio files.

Preferably, the audio headset has a density of less than 0.97 gcm³. Preferably, the audio headset has a mass of less than 35.0 g (preferably less than 34.0 g or more preferably less than 33.0 g).

Optional features of the audio headset correspond to those discussed above in relation to the first or second aspects of the invention.

According to a seventh aspect of the present invention there is provided a kit comprising an audio headset according to the sixth aspect of the invention and an audio player adapted to be demountably retained by the audio headset and comprising an audio signal output interface for outputting an audio signal to the audio headset while the audio player is retained by the audio headset, characterised in that the audio headset and audio player together form a waterproof, buoyant unit having a density of less than 1.00 gcm⁻³.

Preferably, the waterproof, buoyant unit has a density of less than 0.97 gcm⁻³. Preferably, the waterproof buoyant unit has a mass of less than 35.0 g (preferably less than 34.0 g or more preferably less than 33.0 g).

Optional features of the audio player correspond to those discussed in relation to the first three aspects of the invention.

According-to a eighth aspect of the present invention, there is provided an adaptor comprising first and second audio interfaces characterized in that the first audio interface is detachably connectable to an audio interface of an audio player and the second audio interface is detachably connectable to the audio interface of an audio headset according to the first aspect of the invention which has such an interface, wherein the second audio interface is in electrical communication with the first audio interface to relay audio signals from the first audio interface to the second audio interface.

Preferably, the first audio interface is an audio jack plug which is connectable to the audio jack socket of an audio player. Typically, the second audio interface is an audio jack socket which is connectable to the audio player interface of the audio headset. Preferably, the second audio interface is complimentary to the first audio interface, that is to say, the first audio interface is configured to mate with an audio interface corresponding to the second audio interface. For example, the second audio interface may comprise a socket for an audio jack plug and the first audio interface may comprise an audio jack plug of a configuration which would mate with the second audio interface.

Preferably, the adapter comprises an audio player retaining formation. Preferably, the audio player retaining formation comprises a container adapted to contain an audio player. Preferably, the audio player comprises an audio interface which engages with the first audio interface of the adapter when the audio player is retained. Preferably, a retained audio player is in electronic communication with the audio player retaining formation.

The adaptor may be for use with an elongate audio player having a major axis and an audio jack socket which is orthogonal to the major axis.

Preferably, the first and second audio interfaces are arranged in different orientations so that an elongate audio player with an audio jack socket which is orthogonal to the major axis of the elongate audio player may be attached to an audio jack on an audio headset other than orthogonal to the audio jack on an audio headset. Typically, the first and second audio interfaces are orthogonal to each other.

Preferably, the audio player retaining formation is plastically deformable but capable of retaining its shape when plastically deformed to allow a range of sizes of audio players to be retained.

Preferably, the adaptor is waterproof. Where the adaptor comprises a container, the container is preferably waterproof to prevent water damage to an audio player retained therein.

Preferably, the adaptor is buoyant. Preferably, the adapter is brightly coloured.

Accordingly, the invention extends in an ninth aspect to a kit of parts comprising an audio headset according to the first aspect of the invention, wherein the resilient headband comprises an audio player interface, and an adapter according to the second aspect of the invention.

The audio player interface may comprise an audio player jack at a first orientation (typically parallel to the resilient headband) and the adaptor may be arranged to retain an elongate audio player with an audio jack at a different orientation. Thus, the kit of parts may be selected so that an elongate audio player with a jack which is orthogonal to its major axis may be retained with its length parallel to the resilient headband with a jack plug which is also parallel to the resilient headband.

According to a tenth aspect of the present invention, there is provided a generally elongate audio player with a major dimension of less than 10 cm (preferably less than 5 cm), operable to store, decode and play digital audio files, the audio player comprising a plurality of user operable function keys for controlling play back of stored digital audio files and a solid state memory for retrievably storing digital audio files, characterized in that the audio player further comprises an audio jack socket adapted to receive an audio jack plug orientated generally parallel to the length of the audio player enabling attachment to an audio headset according to the first aspect of the invention having an audio player interface in the form of an audio plug arranged thereon which is generally parallel to the resilient headband.

Typically, the audio jack socket is located proximate to a lateral edge of the audio player.

### DESCRIPTION OF THE DRAWINGS

An example embodiment of the present invention will now be illustrated with reference to the following Figures in which:

FIG. 1A is a perspective view of the audio headset;

FIG. 1B is a perspective view of the audio headset indicating the adjustability of the pliable members;

FIG. 2 is a side view of the audio headset when worn around the back of the head;

FIG. 3A is a perspective view of the USB data transfer cable;

FIG. 3B is a perspective view of an alternative data transfer cable;

FIG. 4A is a perspective view of an audio headset with hinged attachments;

FIG. 4B is a perspective view of an audio headset with alternative hinged attachments;

FIG. 5 is a perspective view of an audio headset with an alternative integral audio player;

FIG. 6 is a perspective view of an audio headset with a further alternative audio player;

FIG. 7A is an exploded view of an audio headset, an adapter and an audio player;

FIG. 7B is a perspective view of an audio headset and an assembled adapter and audio player;

FIG. 7C is a perspective view of an elongate audio player comprising an audio jack plug which is parallel to the major axis of the audio player;

FIG. 8 is a perspective view of an alternative embodiment of an audio headset sealably retaining a removable audio player;

FIG. 9 is a perspective view of the removable audio player of FIG. 8; and

FIGS. 12 through 16 illustrate successive steps in a procedure for removing a removable audio player from the audio headset of FIG. 8 and then replacing the removable audio player.

### DETAILED DESCRIPTION OF AN EXAMPLE EMBODIMENT

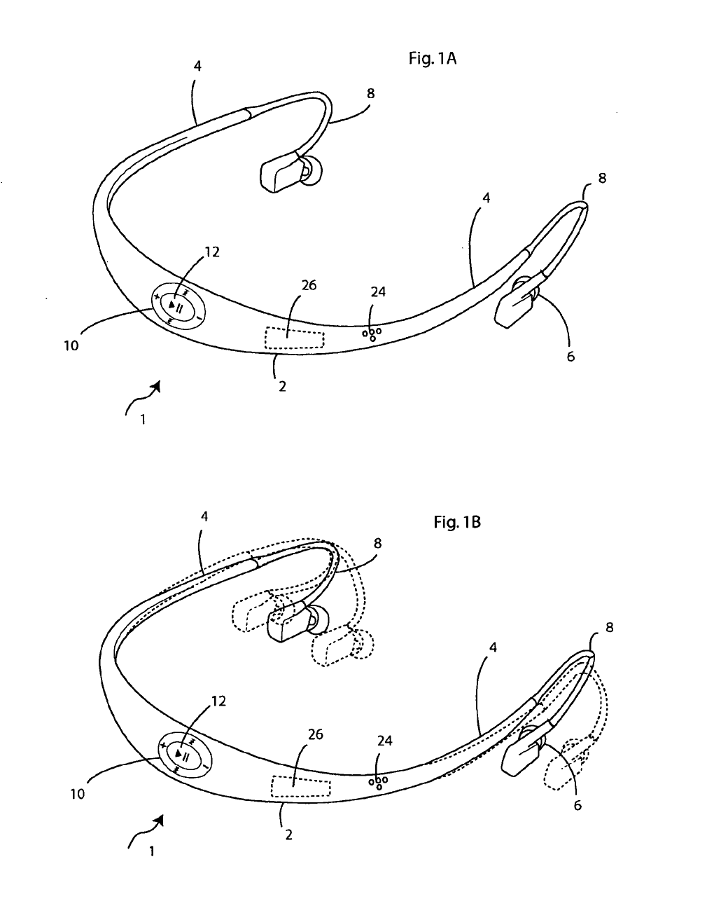

FIG. 1A is a perspective view of an audio headset 1 according to the present invention. The audio headset comprises a resilient headband 2, having first and second end portions 4, and first and second earphones 6 attached by flexible wires 8 to the first and second end portions, respectively. The flexible wires function as pliable members and the adjustability of the resilient headband and pliable members is shown in FIG. 1B. The resilient headband further comprises a plurality of electrical contacts 24 in electrical communication with an internal rechargeable power supply 26 and an integral audio player 10 comprising a plurality of function keys 12. The integral audio player is located intermediate the first and second end portions.

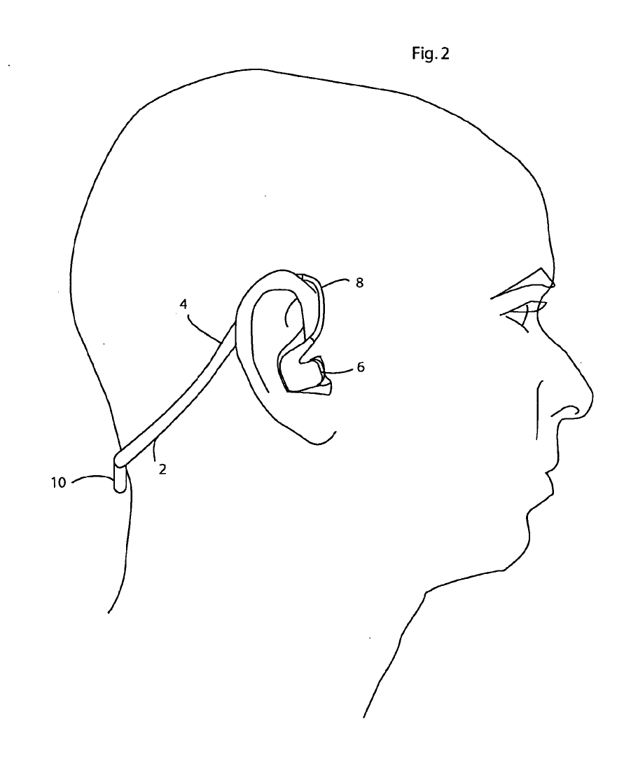

The resilient headband functions to grip a wearer's head when worn. FIG. 2 is a side view of the audio headset when worn around the back of the head. The resilient headband is adapted to closely fit to a wearer's head when worn over the back of the head and has a curved profile arranged to curve downwards from above the ears to match the curve of a wearer's neckline. The end portions extend above a wearer's ears. As the wires are flexible, the attached earphones can be adjusted to engage with a wearer's ear-hole.

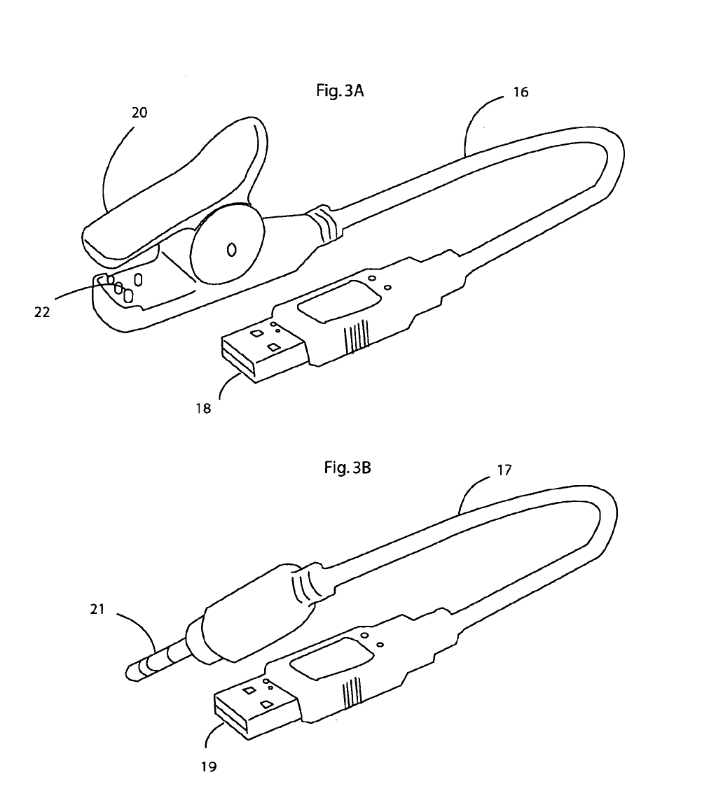

FIG. 3A is a perspective view of a data transfer cable. The data transfer cable 16 comprises a USB (Universal Serial Bus) connector 18, a clip 20 and a plurality of electrical contacts 22. The clip can be connected to the audio headset such that the electrical contacts in the clip are in electronic communication with the electrical contacts of the audio headset. When connected the data transfer cable functions both as a cable to transfer data from an external interface to the audio headset and a power source to recharge the internal power supply of the audio headset.

FIG. 3B is an alternative embodiment of a data transfer cable 17 comprising a USB connector 19. The cable can be connected to an audio headset comprising an audio jack socket by an audio jack plug 21.

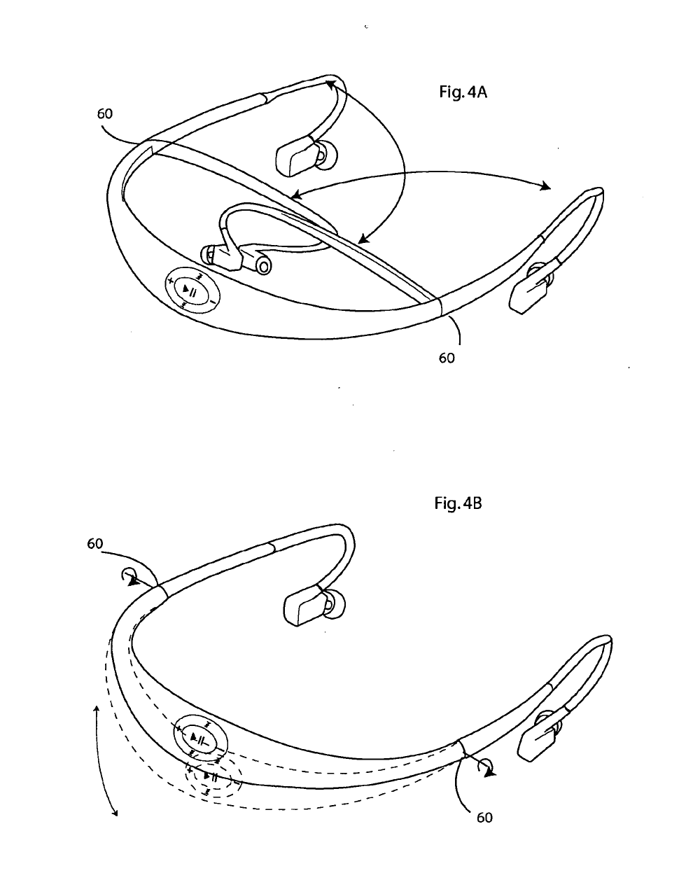

FIG. 4A is a perspective view of an audio headset with hinged attachments 60 proximate to each of the end portions. The hinged attachments allow movement of the end portions within the plane of the audio headset such that each end portion can be folded inwards for convenient storage of the audio headset. FIG. 4B is a perspective view of an audio headset wherein the hinged attachments allow for movement of the end portions vertically out with the plane of the audio headset such that the audio headset can be vertically adjusted for comfort on the back of a wearer's head.

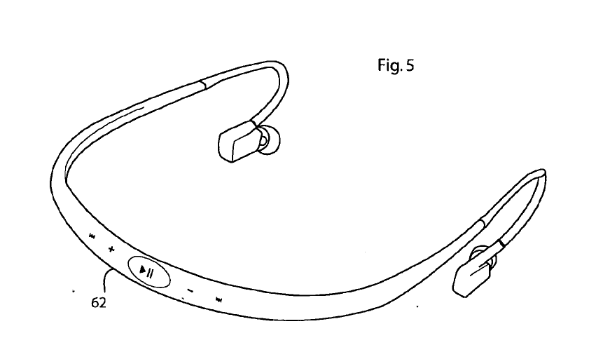

Alternative audio headsets are displayed in FIGS. 5 and 6, each comprising a different integral audio player 62 and 64, respectively.

In use, the audio headset is worn over the back of a wearer's head and the resilient headband grips the wearer's head. The flexible wires are worn over the ears allowing the attached earphones to engage with a wearer's ears. The resilient headband comprises electrical wiring arranged to conduct an audio signal generated by the audio player to the earphones. The audio player is controlled by the plurality of function keys on the audio player.

The resilient headband comprises electrical contacts which are arranged to communicate electronically with corresponding electrical contacts on the clip of the data transfer cable when connected. The electrical contacts function as an interface for data transfer. When connected, the data transfer cable can be connected to the USB port of a personal computer such that audio files stored within the memory of a personal computer can be communicated to the audio player of the resilient headband.

The electrical contacts also function as an interface for power transfer. When connected to the USB port of a personal computer, the data transfer cable is operable to transfer electrical current to the internal rechargeable power supply of the resilient headband. This enables the power supply of the resilient headband to be conveniently recharged whilst data transfer is occurring via a single cable.

The resilient headband is made from a resilient material such as a resilient plastics material. The pliable members are made from a pliable material such as electrical wire which may be entirely flexible or a plastically deformable material which has some resilience such as a suitable plastics material.

The resilient headband also comprises circuitry and components capable of conducting an audio signal from the audio player to the earphones, for example, electrical wiring, Bluetooth circuitry or radio-frequency circuitry.

The earphones comprise circuitry and components capable of receiving and playing an audio signal received from the audio player, for example, a loudspeaker. The earphones further comprises a waterproof seal such that when in use the earphones from a watertight seal with the users ears.

The audio headset has increased comfort over existing audio headsets as the audio headset has minimal bulk over the ears. This has been achieved by locating the audio player behind the wearer's ears. The resilient headband grips the head so the earphones do not press against the ears, further improving comfort.

The pliable members can be adapted for wearer's with a range of head sizes, especially when the pliable members are flexible wires. The flexible wires can be extended to fit a particular wearer's head size, or hang slightly for a smaller head size.

As the audio headset headband is worn around the back of the head, and over the ears, the audio headset has improved aerodynamic properties in comparison to an audio headset worn over the top of the head. Therefore, the audio headset is particularly suited for use during exercise.

Furthermore, as the audio headset is waterproof and has good hydrodynamic properties, it is particularly suited for use during water sports such as swimming. The audio headset is also buoyant in water allowing an audio headset which is dropped in water to be easily retrieved.

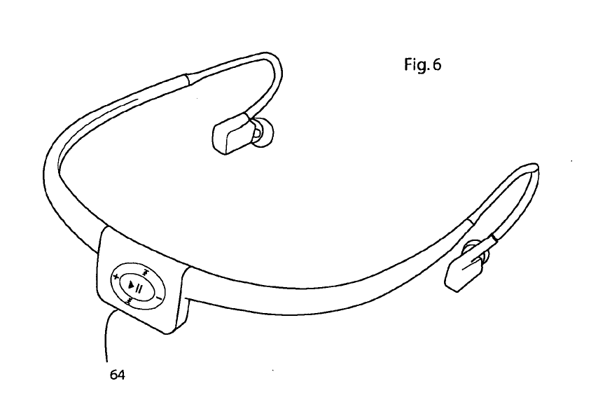

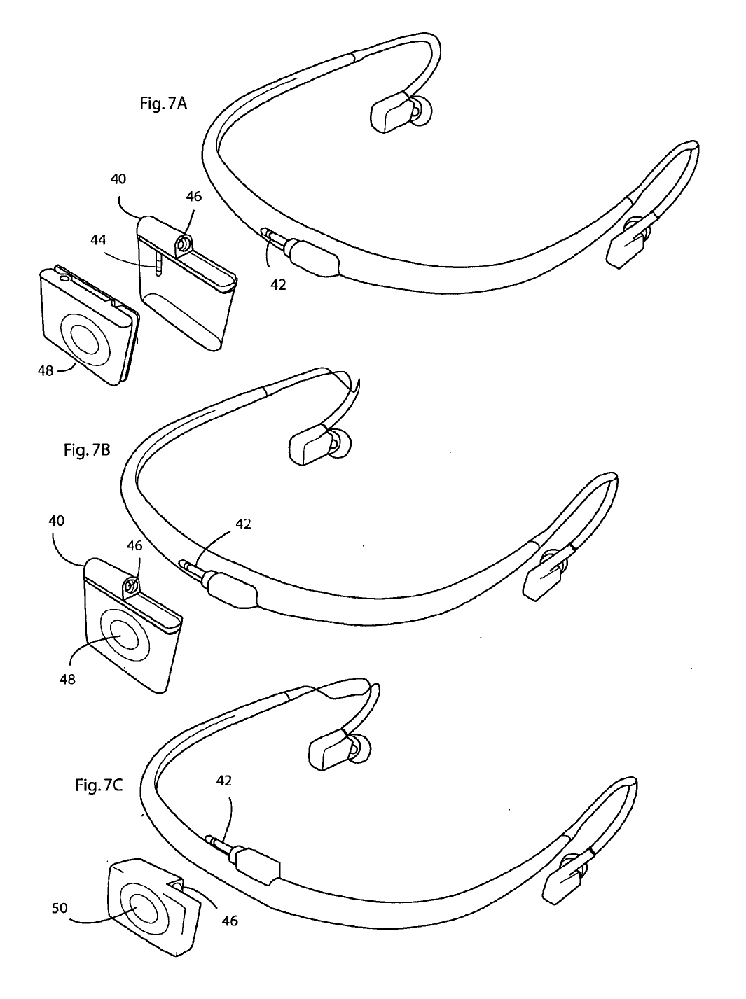

In a second example, shown in FIG. 7A, the audio headset comprises an adapter 40 comprising an audio jack plug 44 (functioning as the first audio interface) and an audio jack socket 46 (functioning as the second audio interface). The audio jack plug is connectable to an audio player 48 and the audio jack socket is connectable to an audio jack plug 42 such that when connected, an audio signal generated by the audio player is relayed to the audio headset via the adapter. The adapter is adapted to connect any suitable audio player to the resilient headband, regardless of the orientation of the audio jack socket of the audio player. The assembled adapter with a retained audio player is shown in FIG. 7B.

In this example, the resilient headband does not require an internal power supply, and acts simply as a means to conduct an audio signal from an attached audio player to the earphones. In use, the connected audio player provides the power necessary to operate the earphones.

The adapter makes a watertight seal with the resilient headband and the audio player when connected. The adapter is buoyant such that it floats in water and can be easily retrieved if dropped in water. The adapter is typically made from a transparent plastics material.

FIG. 7C shows a perspective view of an elongate audio player 50 comprising an audio jack socket 46 which is parallel to the major axis of the audio player. The audio jack socket is located proximate to the upper edge of the audio player and is adapted to mate with an audio jack plug 42 attached parallel to the upper edge of the resilient headband of an audio headset. The orientation of the audio jack socket and audio jack plug allows for a reduction in bulk of the headset, improving the aerodynamic properties of the audio headset.

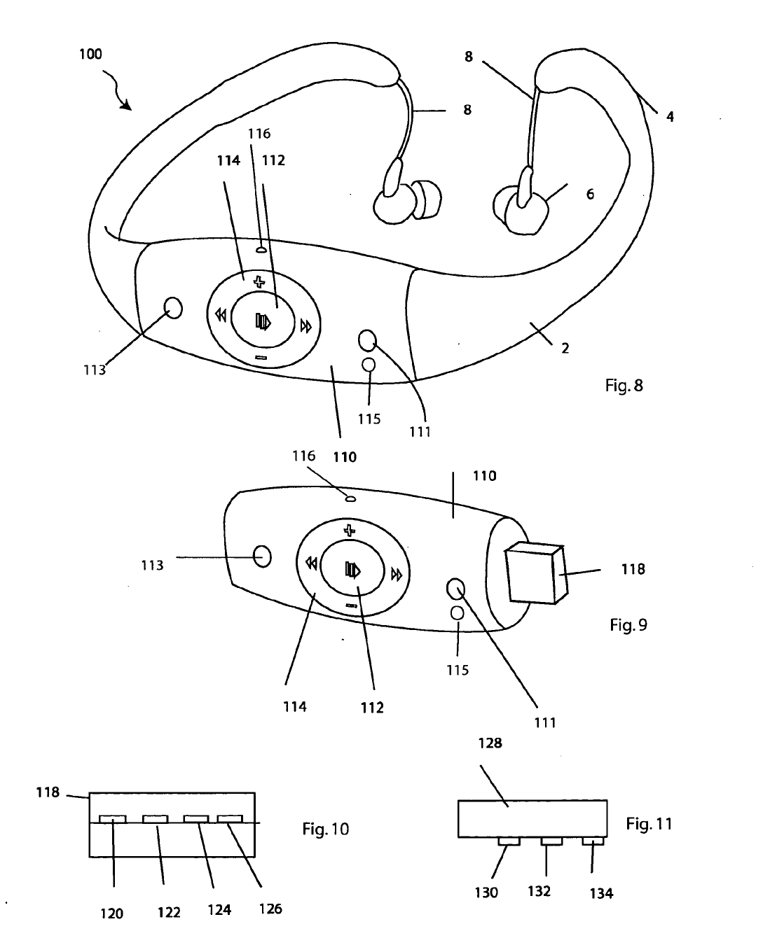

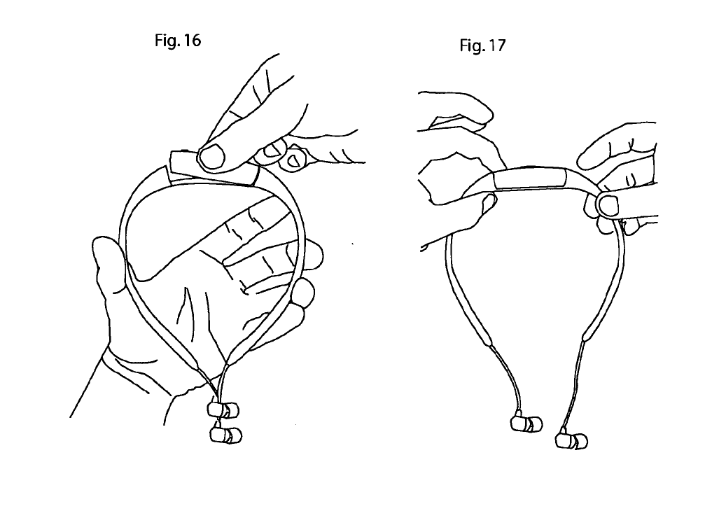

FIG. 8 is a perspective view of an alternative embodiment of an audio headset 110. The headset again comprises a resilient headband 2, having first and second end portions 4, and first and second earphones 6 attached by flexible wires 8 to the first and second end portions, respectively. As before, the flexible wires function as pliable members. The audio headset is adapted for use with an audio player 110, which is retainable by and removable from the audio headset by the procedure illustrated in FIGS. 12 through 16.

The audio player 110 comprises user operable controls 111 to 115, such as buttons, to switch the device on and off, to reset the device, and to allow a user to select audio tracks to play. Light emitting diodes 116 are provided to indicate status information to the user. The audio player further comprises an integral, fixedly mounted USB-A plug 118. This USB plug is the only wired electrical interface of the audio player. The audio player comprises an integral rechargeable battery. The audio player is waterproof. (Optionally the USB plug may not be waterproof as it can be protected from water while it is attached to the audio headset, by a mechanism which is described further below, although is preferred that the audio player is entirely waterproof). The audio player is made predominantly from materials with a density of less than 1.00 gcm⁻³, and includes an internal air space, so that the audio player has a density of around 0.95 gcm⁻³.

Before use with the audio headset, the audio player can be inserted into a USB-A socket, in a corresponding fashion to other USB devices. The audio player can communicate digitally, through the USB plug, with a computer, or other electronic device, to receive audio tracks in an appropriate digital format. These tracks can then be stored within memory, inside the audio player in a standard. At the same time, power can be supplied to the audio player through the USB plug, and used to charge the internal rechargeable battery, in a manner which is well known to those who are skilled in the art.

The audio player can then be mounted to the audio headset in use. FIGS. 12 through 17 illustrate the procedure for removing and replacing the audio player. In the resting position, illustrated in FIG. 12, the audio player is retained in a recess 140 within the resilient headband, between two sealing members 142, defined by edges of the material from which the resilient headband is formed. The resilient headband has a pre-load, so that, in the resting position, without flexural forces applied to the headband, it grips the audio player, in the recess, forming waterproof seals between the sealing members and the audio player. This protects the USB plug, which mates with a corresponding USB socket within the resilient headband. Accordingly, while the audio player is present, the resilient headband is deformed slightly from its resting state, so that it grips and retains the audio player.

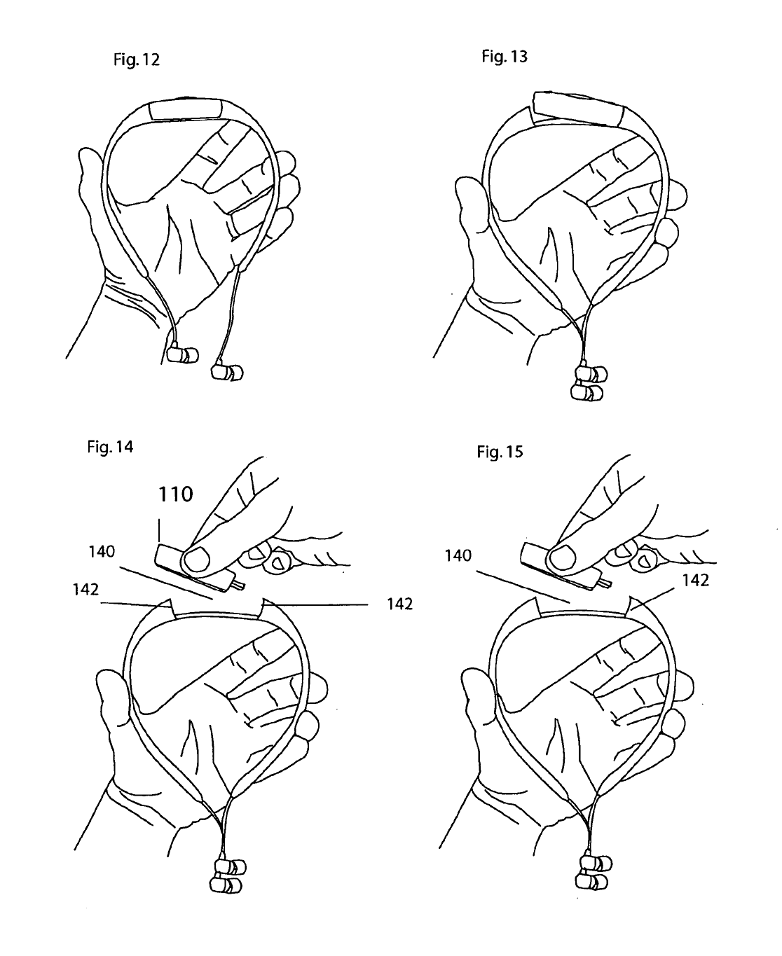

In order to remove the audio player, the resilient headband is squeezed, as illustrated in FIG. 13, so that one end of the audio player disengages from the corresponding sealing member. The audio player can then be removed from the resilient headband. In order to replace the audio player, a user again flexes the resilient headband, before inserting the audio player, so that the USB plug forms electrical connections with the corresponding USB socket, located within the resilient headband. The audio player can then be fully inserted into the recess, as illustrated in FIG. 16 and pushed into place, whereupon all flexural forces can be removed from the resilient headband, and the audio player is then held in place while electrical connections are formed between the USB plug of the audio device and the co-operating USB socket within the resilient headband.

The audio headset is waterproof, and is buoyant, with a density of less than 1.00 gcm⁻³ (typically around 0.95 gcm⁻³). Accordingly, the audio headset, the audio player, and the unit formed when the audio headset retains the audio player each buoyant, or waterproof, and capable of floating on water. Thus, they are a highly suitable for use in outdoor and water sports.

In order to obtain a low overall density, the audio headset is made predominantly from materials with a density of less than 1.00 gcm⁻³, and may optionally include one or more sealed air pockets. In order to minimise the weight of the device (which can less than 35 g in this design), to facilitate buoyancy and to make the device comfortable to wear, the USB socket within the resilient headband 128, comprises only three pins 130, 132, 134 for forming electrical connection with corresponding electrical contacts of the USB plug. Therefore, the socket can connect to and retain the conventional USB-A plug of the audio player, illustrated in FIG. 10, which has the standard four electrical contacts 120, 122, 124 and 126, electrical connections are only made between the three pins which are provided and corresponding electrical contacts in the plug (122, 124 and 126).

In use, the audio player is operated by a user to select one or more audio sources, such as music tracks, which they wish to play. Analogue audio signals, comprising a left channel, a right channel, and a ground line, are output through the three electrical connectors of the plug which have corresponding pins provided in the socket. The audio signals are conducted through the corresponding pins within the socket to the left and right earphones, as appropriate. Thus, the audio player has a first operating mode, for use when it is connected to a conventional computing device, to receive digital audio signals, such as music files in a suitable digital format. In the first operating mode, the audio player's internal battery can also be charged through the USB plug. However, in a second operating mode, the audio player can drive the earphones in the audio headset, through the USB plug, and co-operating socket, without any requirement for there to be a battery or other power source present within the resilient headband. This may be implemented by providing a digital to analogue converter (DAC) and switches within the audio player to bring electrical connectors of the USB plug into electronic communication with the output of the DAC in the second operating mode. Furthermore, the audio device need not include a further jack socket, as is conventional with other audio players, because the USB plug is used both to receive audio signals in digital form, and to output audio signals in an analogue form. This reduces the weight of the audio player, and its cost, and facilitates the provision of a waterproof audio player.

Further modifications can be made within the scope of the invention herein disclosed.

1-50. (canceled)

51. An audio headset (1) comprising a headband (2) having first and second end portions (4), and first and second earphones (6), characterised in that the headband is resilient and adapted to extend partially around and grip a wearer's head, the first and second earphones are attached by pliable members (8) to the first and second end portions, respectively, and the resilient headband is arranged to conduct an audio signal from an audio signal generator to the earphones.

52. An audio headset according to claim 51, wherein the pliable members are plastically deformable but capable of retaining their shape and/or are entirely flexible.

53. An audio headset according to claim 51, wherein the resilient headband is adapted to be worn over the back of the head and/or comprises cushioning on a head engaging side thereof, intermediate the first and second end portions.

54. An audio headset according to claim 51, wherein the audio signal generator is an audio player capable of storing and playing digital audio files.

55. An audio headset according to claim 51, wherein the audio player is integral to the resilient headband.

56. An audio headset according to claim 55, wherein the audio headset comprises a plurality of electrical contacts.

57. An audio headset according to claim 56, wherein the audio headset is connectable to a data transfer cable by a clip via the electrical contacts.

58. An audio headset according to claim 56, wherein the internal power supply is rechargeable by connection to the data transfer cable via the electrical contacts.

59. An audio headset according to claim 55, wherein the data transfer cable is operable to transfer digital audio files from an external source to the audio player via the electrical contacts.

60. An audio headset according to claim 51, wherein the audio player is detachable from the audio headset.

61. An audio headset according to claim 60, wherein the resilient headband comprises an audio player interface for receiving an audio signal from an audio player.

62. An audio headset according to claim 60, wherein the audio player interface is a USB plug or socket for receiving an audio signal from a cooperating USB socket or plug which is integral to an audio player.

63. An audio headset according to claim 62, wherein the audio player interface is operable to receive the audio signal as an analogue signal from the USB plug or socket. BAYS et al.

64. An audio headset according to claims 61, wherein the resilient headband comprises an audio player receiving mounting which is operable between a retaining position in which the audio player receiving mounting retains the audio player and an open position which enables an audio player to be inserted into or removed from the audio player receiving mounting.

65. An audio headset according to claim 64, wherein the audio player receiving mounting forms a waterproof seal with a received audio player in the retaining position.

66. An audio headset according to claim 51, wherein the audio headset is waterproof and/or is buoyant in water.

67. A kit comprising an audio headset according to claim 51, having an audio player interface for receiving an audio signal from a removable audio player, and an audio player which is adapted to be received by the audio headset and which comprises an audio signal output interface suitable for cooperating with the audio player interface of the audio headset and transmitting audio signals to the audio player interface whilst the audio headset retains the audio player.

68. An audio headset comprising a headband and at least one earphone, wherein the resilient headband is arranged to conduct an audio signal to the at least one earphone from a USB socket comprising a plurality of pins operable to make contact with some, but not all, corresponding electrical contacts within a cooperating USB plug.

69. An audio headset according to claim 68, wherein the audio headset comprises a headband and at least one earphone, wherein the resilient headband is arranged to conduct an audio signal to the at least one earphone from a USB socket, which USB socket has at most three pins for making electrical contact with corresponding electrical contacts within a USB plug.

70. An audio headset according to claim 69, adapted to received an analogue audio signal from the USB socket.

71. An audio headset according to claim 69 which is waterproof and buoyant.

72. An audio player comprising a USB plug or socket, wherein the audio player is operable in a first operating mode to receiving audio data in the form of digital signals through the USB plug or socket and, in a second operating mode, is operable to output audio data in the form of analogue signals through the USB plug or socket.

73. An audio headset comprising a headband and at least one earphone, wherein the audio headset is adapted to conduct a received audio signal from an audio signal generator to the at least one earphone, characterised in that the audio headset is waterproof and buoyant, having a density of less than 1.00 gcm⁻³.

74. An adaptor (40) comprising first and second audio interfaces (44, 46) characterized in that the first audio interface is detachably connectable to an audio interface of an audio player and the second audio interface is detachably connectable to the audio interface of an audio headset according to claim 51, wherein the second audio interface is in electrical communication with the first audio interface to relay audio signals from the first audio interface to the second audio interface.

75. An elongate audio player (50) with a major dimension of less than 10 cm operable to store, decode and play digital audio files, the audio player comprising a plurality of user operable function keys for controlling play back of stored digital audio files and a solid state memory for retrievably storing digital audio files, characterized in that the audio player further comprises an audio jack socket (46) adapted to receive an audio jack plug (42) orientated generally parallel to the length of the audio player enabling attachment to an audio headset (1) according to claim 60 having an audio player interface in the form of an audio plug arranged thereon which is generally parallel to the resilient headband.
